(19) United States
(12) Patent Application Publication
(10) Pub. No.: US 2007/0169065 A1
(43) Pub. Date: Jul. 19, 2007

(54) COMPUTER PROGRAM WITH METADATA MANAGEMENT FUNCTION

(76) Inventors: Philippe A. Janson, Wadenswil (CH); Tadeusz J. Pietraszek, Rueschlikon (CH); Matthias Schunter, Zurich (CH); Chris P. Vanden Berghe, Zurich (CH)

Correspondence Address: LAW OFFICE OF IDO TUCHMAN (YOR), 82-70 BEVERLY ROAD, KEW GARDENS, NY, 11415, US

(21) Appl. No.: 11/554,856

(22) Filed: Oct. 31, 2006

(30) Foreign Application Priority Data
Oct. 31, 2005 (EP) 05023799.9

(51) Int. Cl. G06F 9/44

(52) U.S. Cl. 717/162

(57) ABSTRACT

One embodiment disclosed is a computer program with metadata management function. The computer program includes a basic program module and a metadata management module. The metadata management module includes intercept definition elements that define intercept points in the basic program module. The metadata management module further includes intercept instructions that define metadata operations to be performed when an intercept point occurs in the basic program module.

### CROSS-REFERENCE TO RELATED APPLICATIONS

This application claims priority under 35 U.S.C. § 119 to European Patent Application No. 05023799.9 filed Oct. 31, 2005, the entire text of which is specifically incorporated by reference herein.

### BACKGROUND OF THE INVENTION

The present invention is related to a computer program, a method and a computer system with metadata management function.

Metadata means data about data. It can contain all kind of information about data elements, e.g. describe how, when, by whom and in what format a particular data element was created and/or amended.

The rise of the Internet as a medium for business to business transactions and ever-changing legislation, such as accountability and compliance laws or privacy protection and retention laws encourage companies to improve the level of data protection and monitoring throughout the lifetime of data. This typically involves a time-consuming and costly retrofitting of metadata provisioning and data policy enforcement functionality to legacy applications.

The programming language Perl provides some limited metadata provisioning and comprises a feature which allows the marking of variables which originate from an untrusted source. The goal of this technique is to warn a developer when using unvalidated data.

Another known technique is to perform statical analysis of application code to detect policy violations. Complete statical analysis is however not feasible for real-world enterprise applications.

### BRIEF SUMMARY OF THE INVENTION

Embodiments of the present invention provide improved solutions for metadata management.

According to one aspect of the present invention, there is presented a computer program with metadata management function. The computer program includes a basic program module, and a metadata management module with intercept definition elements which define intercept points in the basic program module and with intercept instructions which define metadata operations to be performed when an intercept point occurs in the basic program module.

According to this aspect of the invention the computer program has a modular structure with a basic program module and a metadata management module. These two modules are linked by means of the intercept definition elements and the intercept instructions. This modular structure has several advantages. It allows the addition of metadata functionality to existing applications and basic program modules respectively in a very efficient and smooth way with little or no modifications of the basic program module. In a lot of application scenarios the addition of metadata functionality can be limited to defining an appropriate metadata and data protection policy, which does not require specific knowledge about the basic program module. This aspect of the invention is also very useful for newly designed programs, i.e. in cases where a new basic program module as well as a corresponding new metadata management module is written. The modular structure has the further advantage that changes of the metadata management function, e.g. a change of the metadata policy, can be implemented very easily without changing the basic program module.

The intercept definition elements define intercept points in the basic program. In other words, they define program events in the basic program that the metadata management module should intercept. Examples of intercept definition elements are “intercept all credit card operations of credit card company X”, “intercept all database calls” or “intercept all string addition operations”. If the metadata management module has detected such an intercept point in the basic program module, it performs an intercept instruction. Such an intercept instruction is a defined metadata operation, e.g. an assignment, a change or an update of metadata or an enforcement operation of a metadata policy.

According to an embodiment of this aspect of the invention the metadata management module includes a first, a second and a third metadata management component. The first metadata management component is provided for assigning metadata to data elements of the basic program module. The second metadata management component is provided for updating the metadata of the data elements. The third metadata management component is provided for enforcing a metadata policy.

According to this embodiment the metadata management module has a modular structure as well. This allows a flexible and efficient implementation of the metadata management module. In addition, the individual components of the metadata management module can be adapted to new requirements separately without changing the other modules. As an example, if a new metadata policy has to be implemented, only the third metadata management module has to be amended, while the first and the second metadata management module can remain unchanged.

The first metadata management component is responsible for assigning metadata to data elements of the basic program module. Data elements can be in particular variables and parts of variables, but also constants. The assigned metadata can contain any information about the data stored in the data element. Preferably the metadata contains information that is useful to enforce a metadata policy, e.g. information about the origin, owner, history or privacy of the data.

The metadata itself may refer to the whole data element as well as to a part of the data element. To illustrate this with an example, while creating an XML-document with personally identifiable information (such as user name and address), the metadata can be assigned only to a part of the XML-document in order to indicate that only a part of the XML-document is personally identifiable. This is true regardless of the representation of the XML-document, be it an XML-tree or a serialized textual representation.

According to a further embodiment of the invention the first metadata management component comprises intercept definition elements which define as intercept points a set of points in the basic program module where data is entered into the computer program. The set of intercept points might be limited to specific input events, but can also comprise all input events. This allows a flexible and efficient metadata assignment.

According to a further embodiment of the invention the metadata assignment can be done automatically, e.g. by assigning to all data which is read from a user or a network the metadata “untrusted”, while assigning to all data, in particular constants, in the program code that are written by the programmer the metadata “trusted”. According to another embodiment of the invention the metadata assignment can be done by the user. For example the user might indicate which data input is sensitive or personally identifiable and which is not.

According to a further embodiment of the invention the first metadata management component assigns metadata only to a limited number of data types. This embodiment acknowledges that the basic data representation can be done by using only a limited number of basic data types, e.g. byte arrays, strings, characters and numeric values. This allows to implement a complete metadata management function by assigning metadata only to these basic types of data. Moreover, the number of native platform functions performing operations on these basic data types is limited and defined by the Application Program Interface (API) of the platform. An example for such a platform is the Java runtime environment.

The intercept points of the first metadata management component establish input vectors. The second metadata management component updates the metadata assigned to the data elements. Preferably this is done automatically whenever an operation is performed on the data elements.

According to a further embodiment of the invention the second metadata management component comprises intercept definition elements which define as intercept points a set of functions that are operable on data elements of the basic program module. The term function shall comprise also operators. Whenever a function of the set occurs in the basic application, the metadata of the corresponding data elements are updated. If the metadata is only assigned to a limited number of basic data types, as described above, the number of functions performing operations on these basic data types is limited as well and defined by the Application Program Interface (API). As all other functions and libraries only use the API of the platform, the set of functions that define the intercept points only need to comprise these basic functions (e.g. concatenation and string expansion). Preferably the set of functions which define the intercept points for updating the metadata comprises only such functions which really require a change of the metadata. For example, a function which only changes the capitalization of a string requires no amendment of the metadata of the corresponding data element. The capitalization of a string is generally not relevant for enforcing a metadata policy. On the other hand, the functions “concatenate strings” or “take a part of a string” require an update of the corresponding metadata.

The third metadata management component is adapted to enforce a metadata policy. Such a metadata policy defines which data or parts thereof may appear in a particular output vector. Arbitrary or regular checks may be performed, depending on the respective policy. For example, one metadata policy may require that data are only disclosed within a specific organization. To enforce such a metadata policy, the third metadata management module would check the recipient of the data. Another metadata policy may require that data are checked for special characters. Another metadata policy may require that some kind of data may not be printed or stored.

According to a further embodiment of the invention the third metadata management component comprises intercept definition elements that define as intercept points a set of actions performed on data elements of the basic program module. The intercept points of this third data management component establish output vectors.

According to a further embodiment of the invention the computer program is adapted to store the metadata as part of a data element (e.g. an object in an object oriented environment). This part of a data element can e.g. be an additional class member variable. This embodiment has the advantage that the metadata can be quickly accessed and that every data element has metadata assigned from the very first time of its creation.

According to a further embodiment of the invention the computer program is adapted to store the metadata in a central repository. The central repository can e.g. be implemented as a central hash table addressed by some unique data element identifier. This embodiment has the advantage that no modifications to the internal object representation are required.

According to a further embodiment of the invention the metadata management function is implemented by means of Aspect Oriented Software Development. This is a very simple and efficient solution, in particular if the basic program is written in a program language which supports Aspect Oriented Software Development. An example for an Aspect Oriented Programming Language is AspectJ for Java. AspectJ is a trademark of PARC Inc.

According to a further embodiment of the invention the metadata management module is provided for enforcing data protection. As an example, the privacy of the data can be protected. In this embodiment the metadata contains personally identifiable information or other sensitive information.

According to a further embodiment of the invention the metadata management module is provided for enforcing security. According to this embodiment the metadata management module might be used to defend the program against injection attacks or for access control mechanisms based on the origin of data.

According to another aspect of the present invention, there is presented a method for providing a metadata management function to a basic program module of a computer program, the method includes the steps of programming a metadata management module with intercept definition elements which define intercept points in the basic program module and with intercept instructions which define metadata operations to be performed when an intercept point occurs in the basic program module, and linking the metadata management module to the basic program module.

According to another aspect of the present invention, there is presented a method for running a computer program with metadata management function, the method includes the steps of starting a basic program module and a metadata management module of the computer program, whereas the metadata management module comprises intercept definition elements which define intercept points in the basic program module and intercept instructions which define metadata operations to be performed when an intercept point occurs in the basic program module, observing the basic program module for the occurrence of intercept points by means of the metadata management module, and performing intercept instructions when an intercept point occurs in the basic program module.

According to another aspect of the present invention, there is presented a method for providing a metadata management function to a basic program module of a computer program, the method comprising the steps of analyzing the basic program module, creating intercept definition elements which define intercept points in the basic program module, creating intercept instructions which define metadata operations to be performed when an intercept point occurs in the basic program module, creating a metadata management module by means of the intercept definition elements and the intercept instructions, and linking the metadata management module to the basic program module.

According to another aspect of the present invention, there is presented a computer system. The computer system includes a computer program with metadata management function. The computer program includes a basic program module, a metadata management module with intercept definition elements which define intercept points in the basic program module, and intercept instructions which define metadata operations to be performed when an intercept point occurs in the basic program module.

### BRIEF DESCRIPTION OF THE SEVERAL VIEWS OF THE DRAWINGS

Reference will now be made, by way of example, to the accompanying drawings, in which:

FIG. 1 shows a schematic illustration of the modules of a computer program according to an embodiment of the present invention.

FIG. 2 shows a schematic illustration of the structure of a metadata management module according to a first embodiment of the present invention.

FIG. 3 shows a schematic illustration of the structure of a metadata management module according to a second embodiment of the present invention.

FIG. 4a shows an exemplary embodiment of a flow chart of a run of a basic program module.

FIG. 4b shows an exemplary embodiment of a flow chart of a run of the basic program module in cooperation with a metadata management module.

### DETAILED DESCRIPTION OF THE INVENTION

In the following, a description will be provided of the present invention through an embodiment of the present invention. However, the following embodiments do not restrict the invention in the scope of the invention and all combinations of features explained in the embodiment are not always essential to means of the invention for solving the problems.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

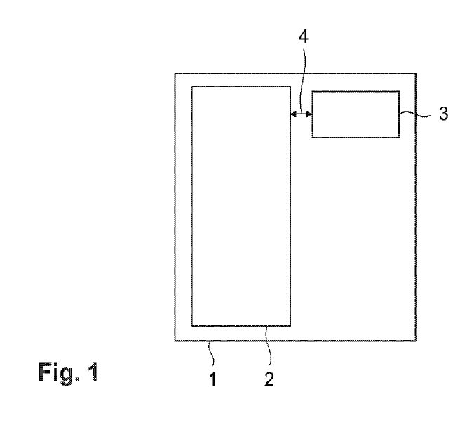

FIG. 1 shows a schematic illustration of the structure of a computer program 1 according to the invention. The computer program 1 comprises a basic program module 2 and a metadata management module 3. The basic program module 2 and the metadata management module 3 interact with each other via an interface 4.

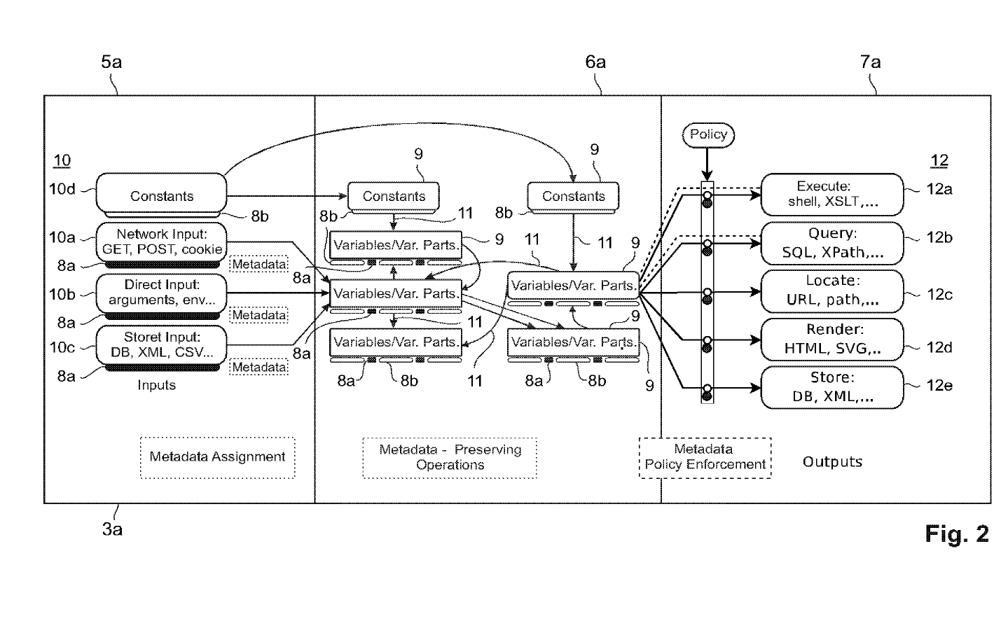

FIG. 2 shows a schematic illustration of the structure of a first embodiment 3a of the metadata management module 3. The metadata management module 3a comprises a first metadata management component 5a, a second metadata management component 6a and a third metadata management component 7a. The first metadata management component 5a is provided for assigning metadata 8a and 8b to data elements 9. The data elements 9 are variables, constants or parts of variables or constants of the basic program module 2. The first metadata management module 5a observes the program running in the basic program module 2 for intercept points. This is done by means of a set 10 of intercept definition elements that define the intercept points in the basic program module 2. The exemplary embodiment of FIG. 2 shows four intercept definition elements 10a, 10b, 10c and 10d. In general, the intercept definition elements may contain broad definitions that are met by a lot of intercept points as well as very narrow and specific definitions that are met only by a few intercept points. In this exemplary embodiment, the intercept definition element 10a defines as intercept points all network inputs. As an example, a network input could be the content of a requested webpage or other data received from an internal or external network. The intercept definition element 10b defines as intercept points all direct inputs. As an example, a direct input could be a user input performed via a user interface, e.g. a keyboard or runtime arguments. The intercept definition element 10c defines as intercept points all stored inputs. As an example, a stored input could be received from an internal or external database or an internal or external storage medium. Finally, the intercept definition element 10d defines as intercept points all constants in the basic program module 2. These constants are inherently embodied in the basic program module 2 and defined by the programmer and developer respectively of the basic program module.

The intercept points defined by the intercept definition elements 10a, 10b and 10c establish input vectors of the basic program module 2. According to this exemplary embodiment the three intercept definition elements 10a, 10b and 10c are linked with the same intercept instruction “Assign the metadata untrusted”. In other words, all network input data, all direct input data and all stored input data is assigned with the metadata 8a “untrusted”. This is indicated in FIG. 2 with the black filled color of the elements representing the metadata 8a. On the other hand, the intercept definition element 10d is defined as “Assign the metadata trusted”. In other words, all constants, i.e. all input from the developer and programmer respectively of the basic program module 2 of the computer program 1 is assigned with the metadata 8b “trusted”. This is indicated in FIG. 2 with the gray filled color of the elements representing the metadata 8b.

In this exemplary embodiment the intercept definition elements 10a, 10b, 10c and 10d as well as the intercept instructions are defined rather broadly. It should be noted that according to other embodiments of the invention also very specific and narrow definitions of the intercept definition elements and the intercept instructions can be useful. This generally increases the number of intercept definition elements. As an example, an intercept definition element could be defined as “Input of credit card number credentials of credit card company X” and a corresponding intercept instruction could be “Assign metadata credit card number credentials of credit card company X”.

In object oriented languages the data types and operations are potentially unlimited (classes and all methods). However, the basic data type representation uses only a small number of basic types (e.g. byte arrays, strings, characters, numeric values). Therefore, according to a preferred embodiment, the metadata 8a and 8b is assigned only to these basic data types.

The second metadata management component 6a is provided for updating the metadata 8a, 8b of the data elements 9. In other words, the second metadata management component 6a provides metadata preserving operations to preserve and update respectively the metadata 8a, 8b assigned to the data elements 9. The arrows between the data elements 9 indicate a set of intercept definition elements 11 which might comprise all possible kind of operation performed on or between the data elements 9. The second metadata management module 6a intercepts preferably all relevant data operation performed by the basic program module 2 on data elements 9. As described above, the basic data representation uses generally only a small number of basic data types. Based on this assumption, the number of native platform functions performing operations on these basic data types is limited as well and defined by the Application Programming Interface (API) of the respective platform. As all other functions and libraries only use the API of the specific platform, only these basic functions and operators (e.g. concatenation, string expansion) need to be instrumented. Accordingly, a limited set of intercept definition elements 11 can be defined for the metadata management component 6a.

As an example, one intercept definition element 11 could be “concatenation of data elements 9”. This intercept definition element could be linked with the intercept instruction “Preserve both metadata”. In other words, if a concatenation operation is performed with two data elements 9, the metadata of both data elements is preserved. As an example, the concatenation of a string received as direct input data with a constant comprising a string results in a data element 9 that preserves the metadata 8a (untrusted) for the direct input data as well as the metadata 8b (trusted) for the data of the constant. This is indicated in FIG. 2 with the aggregation of black metadata 8a (untrusted) and gray metadata 8b (trusted) allocated to the data elements 9. Upon each operation that meets the definition of an intercept definition element the metadata 8a, 8b which is an indication of the specific origin of the involved data (untrusted or trusted) is preserved and updated respectively. As another example, one intercept definition element 11 could be the operation “capitalize”. This intercept definition element 11 could be linked with the intercept instruction “Preserve the metadata”. In other words, if a capitalization operation is performed on a data element 9, the metadata will not be changed. As an example, the capitalization of a string received as direct input data results in a data element 9 that contains the preserved metadata 8a (untrusted).

The third metadata management component 7a is provided for enforcing a metadata policy. It observes the program running in the basic program module 2 for specific intercept points, also referred to as output vectors. This is done by means of intercept definition elements 12 which define the intercept points in the basic program module 2 which are regarded as output vectors. In general, the intercept definition elements 12 may contain broad definitions that are met by a lot of intercept points as well as very narrow and specific definitions that are met only by a few intercept points. The exemplary embodiment of FIG. 2 shows five intercept definition elements 12a, 12b, 12c, 12d and 12e.

In this exemplary embodiment, the intercept definition element 12a defines as intercept points all outputs performed as an execution operation, e.g. the execution of a shell or the transformation of a XML-document by means of the XSLT-language. The intercept definition element 12b defines as intercept points all outputs performed as a query operation, e.g. a query addressing portions of an XML-document by means of XPath or a query to receive data from a relational database system by means of the SQL language. The intercept definition element 12c defines as intercept points all outputs performed as a locate operation, e.g. outputting an URL or a path. The intercept definition element 12d defines as intercept points all outputs performed as a rendering operation, e.g. displaying the content of a HTML document on a screen by means of a rendering engine. Finally, the intercept definition element 12e defines as intercept points all outputs performed as store operation, e.g. the storage in a database or the storage on a portable medium such as a DVD or an USB stick.

The five intercept definition elements 12a, 12b, 12c, 12d and 12e might be linked with the same intercept instruction or they might be linked with different intercept instructions. For example, the intercept definition element 12e might be linked with the intercept instruction “Allow only the storage of data with metadata 8b “trusted”. As another example, the intercept definition element 12d might be linked with the intercept instruction “Do not show any untrusted and dangerous HTML-documents on the screen”. This prevents Cross Site Scripting (XSS) attacks.

The metadata management module 3a preserves the trustworthiness of data assigned to data elements 9 during the lifetime of an application. By means of the assigned metadata 8a and 8b the origin of the data (trusted or untrusted) can be monitored throughout the applications lifetime.

The set of intercept definition elements 10, 11 and 12 and the corresponding intercept instructions and intercept points establish the interface 4 between the basic program module 2 and the metadata management module 3.

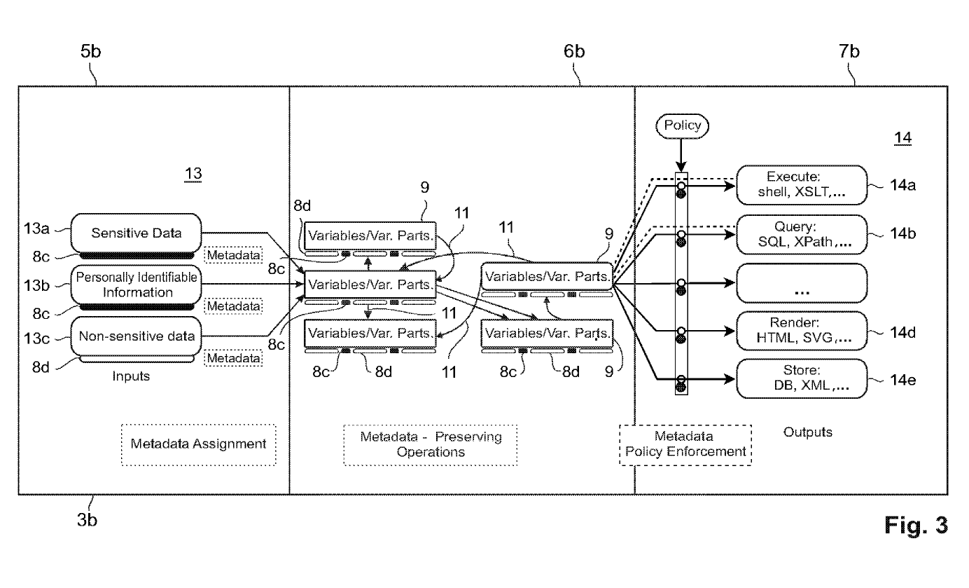

FIG. 3 shows a schematic illustration of the structure of a second embodiment 3b of the metadata management module 3. The metadata management module 3b comprises a first metadata management component 5b, a second metadata management component 6b and a third metadata management component 7b.

The first metadata management component 5b is provided for assigning metadata 8c and 8d to data elements 9. The data elements 9 are variables or parts of variables of the basic program module 2. The first metadata management module 5b observes the program running in the basic program module 2 for intercept points. This is done by means of set 13 of intercept definition elements that define the intercept points in the basic program module 2. The exemplary embodiment of FIG. 3 shows three intercept definition elements 13a, 13b and 13c. The intercept definition element 13a defines as intercept points all sensitive data inputs, the intercept definition element 13b defines as intercept points all data input comprising personally identifiable information and the intercept definition element 13c defines as intercept points all input data comprising non-sensitive data. According to this exemplary embodiment the intercept definition elements 13a and 13b are linked with the intercept instruction “Assign the metadata private”. In other words, all sensitive input data and all input data comprising personally identifiable information is assigned with the metadata 8c “private”. This is indicated in FIG. 3 with the black filled color of the elements representing the metadata 8c. On the other hand, the intercept definition element 13c is linked with the intercept instruction “Assign the metadata non-private”. In other words, all non-sensitive input data is assigned with the metadata 8d “non-private”. This is indicated in FIG. 3 with the gray filled color of the elements representing the metadata 8d. The marking whether data should be classified as sensitive, personally identifiable or non-sensitive is preferably done by human intervention. i.e. by user input.

The second metadata management component 6b is provided for updating the metadata 8c, 8d of the data elements 9. In other words, the second metadata management component 6b provides metadata preserving operations to preserve and update respectively the metadata 8c, 8d assigned to the data elements 9. For example, if a concatenation operation is performed on a data element 9, for example a concatenation of a sensitive input data with non-sensitive input data, the resulting data element 9 preserves the metadata 8c (private) for the sensitive input data as well as the metadata 8d (non-private) for the non-sensitive input data. This is indicated in FIG. 3 with the aggregation of black metadata 8c (private) and gray metadata 8d (non-private) allocated to the data elements 9. The arrows between the data elements 9 indicate a set of intercept definition elements 11 which might comprise all possible kind of operation performed on or between the data elements 9. The second metadata management module 6b intercepts preferably all relevant data operation performed by the basic program module 2 on data elements 9. Upon each operation the specific origin of the involved data (private or non-private) is preserved.

The third metadata management component 7b is provided for enforcing a metadata policy. It observes the program running in the basic program module 2 for specific intercept points, also referred to as output vectors. This is done by means of a set of intercept definition elements 14 which define the intercept points in the basic program module 2 which should be regarded as output vectors. The exemplary embodiment of

FIG. 3 shows four intercept definition elements 14a, 14b, 14d and 14e. This intercept definition elements are the same or similar to the intercept definition elements described with reference to FIG. 2. Accordingly, the intercept definition element 14a defines as intercept points all or a specific set of execution outputs, the intercept definition element 14b defines as intercept points all or a specific set of query outputs, the intercept definition element 14d defines as intercept points all or a specific set of render outputs and the intercept definition element 14e defines as intercept points all or a specific set of store outputs. The four intercept definition elements 14a, 14b, 14d and 14e might be linked with the same intercept instruction or they might be linked with different intercept instructions. For example, the intercept definition element 14e might be linked with the intercept instruction “Allow only the storage of data with metadata non-private”. As another example, the intercept definition element 14d might be linked with the intercept instruction “Do not display data on a screen linked with the metadata “private”. As another example, the intercept definition element 14d might be linked with the intercept instruction “Do not display data elements on a screen which are linked with the metadata “Password”.

The metadata management module 3b preserves data privacy throughout the lifetime of the application.

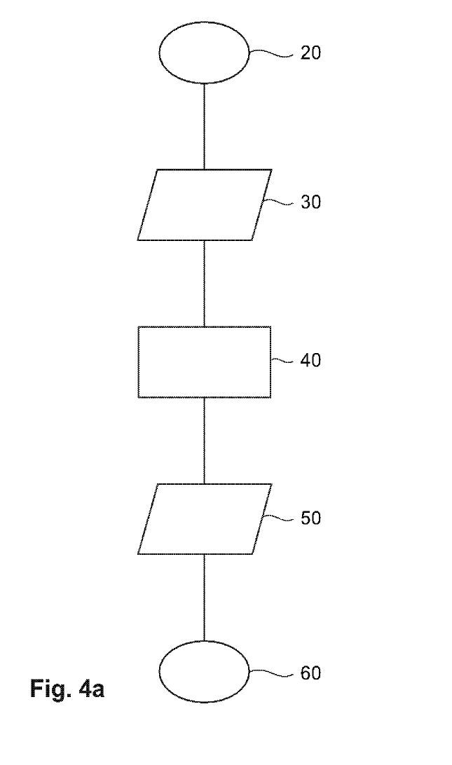

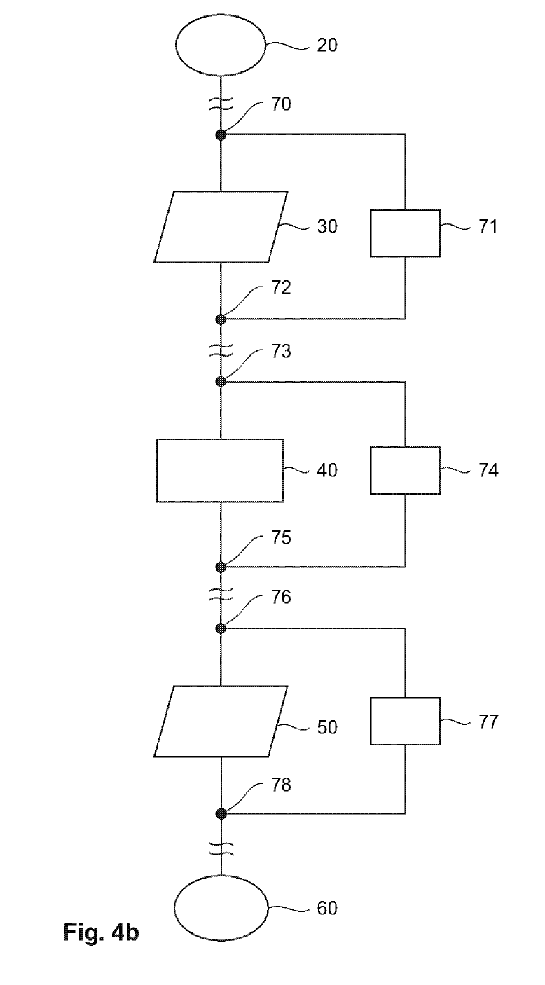

FIG. 4a shows a flow chart of an exemplary embodiment of the program flow of a basic program module 2 of the computer program 1 according to FIG. 1. In step 20 the computer program 1 and the basic program module 2 are started.

In a following input step 30 an input operation is performed. As an example, the input operation 30 could be the input of credit card credentials which are written to a data element 9. As further examples, the input step 30 could be any input operation performed in the first metadata management components 5a and 5b as described with reference to FIG. 2 and FIG. 3.

In a following operation step 40 operations are performed on data of the data elements 9, e.g. a concatenation or a string expansion. As further examples, the operation step 40 might represent all possible kind of operation performed on or between the data elements as described with reference to FIG. 2 and FIG. 3.

In a subsequent output step 50 output operations are performed on the data of the data elements 9. For example, the output step 50 could be any output operation performed in the third metadata management components 7a and 7b as described above with reference to FIG. 2 and FIG. 3.

In step 60 the exemplary embodiment of the program flow of the basic program module 2 ends.

FIG. 4b. shows a flow chart of an exemplary embodiment of the program flow of the basic program module 2 in interaction with the metadata management module 3.

In step 20 the computer program 1, the basic program module 2 and the metadata management module 3 are started. Usually, the basic program module 2 and the metadata management module 3 are compiled or weaved together and run as one executable program. The metadata management module 3 observes the basic program module 2 whether it contains intercept points, i.e. it is observed whether the basic program module 2 comprises points that meet the definition of the intercept definition elements. Preferably, the metadata management module 3 comprises a set of intercept definition elements. In the programming language AspectJ intercept points are called “join points” and the intercept definition elements are called “pointcuts”.

Subsequently, the computer program 1 reaches an intercept point 70. This intercept point 70 meets the definition of a corresponding intercept definition element. In this example, we assume that the intercept point 70 meets the definition of an intercept definition element “Credit card credential Input”. The intercept definition element “Credit Card Credential Input” is linked with an intercept instruction 71 which defines which Code should be executed before, after or around the intercept point 70. In this example the intercept instruction could be as follows:

a. Receive credit card credential input data

b. Assign metadata “credit card credential”

c. Return to basic program module 2 after the intercept point.

In this example the intercept instructions are executed instead of (around) the code which was defined in the intercept definition element. At a return point 72 the basic program module 2 is continued. In the programming language AspectJ intercept instructions are called “Aspects”.

Subsequently, the program reaches a further intercept point 73. In this example, we assume that the intercept point 73 meets the definition of a corresponding intercept definition element “Change capitalization of string”. The intercept definition element “Change capitalization of string” is again linked with an intercept instruction 74 that defines which code should be executed before, after or around the intercept point 73. In this example the intercept instruction could be as follows:

d. Change capitalization of string

e. Preserve metadata of string

f. Return to basic program module after the intercept point.

At a return point 75 the basic program module 2 is continued.

Subsequently, the program reaches an intercept point 76. In this example, we assume that the intercept point 76 meets the definition of a corresponding intercept definition element “Store credit card credentials”. The intercept definition element “Store credit card credentials” is linked with an intercept instruction that defines which Code should be executed before, after or around a corresponding intercept point. In this example the intercept instruction could be as follows:

g. Prevent storing of credit card credentials

h. Issue an error message

i. Return to basic program module after the intercept point.

At a return point 78 the basic program module 2 is continued.

In step 60 the exemplary embodiment of the program flow of the basic program module 2 ends.

In the following some exemplary embodiments of source code of the metadata management module 3 in the programming language Aspect J is presented:

To illustrate the exemplary embodiments in a simple way, the following simplifications have been made:
The first metadata management component shows only 2 relevant intercept definition elements (input vectors)
The second metadata management component is restricted to only a few intercept definition elements (string operations: concatenation and copying)
The third metadata management component is restricted to only a few intercept definition elements (string output and database queries)

Furthermore the input and output policies are not shown and the intercept instructions (code in the aspect bodies) are omitted.

The code reads as follows:

package aoid.aspects;
public aspect MetadataAspect {

/******* first metadata management component: Metadata

Assignment *******/

/******* Input vectors -- GET/POST *******/
pointcut getHttpServletRequestParam( ): call(String

HttpServletRequest.getParameter(..));

String around( ): getHttpServletRequestParam( ) {

{ ... }

}
/******* Input Vectors -- cookies *******/
pointcut getCookieValue (Cookie c): call(String

Cookie.getValue(..)) && target(c);

String around(Cookie c): getCookieValue(c) {

{ ... }

}
/******* second metadata management component: Metadata

Preserving Operations *******/

/******* Context-Preserving String Operations --

concatenation *******/

/* appending string buffer */

pointcut appendStringBuffer(StringBuffer stringBuffer,

String string): call(StringBuffer StringBuffer.append(*)) &&
args(string) && target(stringBuffer) && !within(aoid.aspects.*);

around(StringBuffer stringBuffer, String string):

appendStringBuffer(stringBuffer, string) {

{ ... }

}
/* creating String from StringBuffer */
pointcut createString(StringBuffer stringBuffer):

call(String Object.toString( )) && target(stringBuffer) &&
!within(aoid.aspects.*);

String around(StringBuffer stringBuffer):

createString(stringBuffer) {

{ ... }

}
/* creating StringBuffer from String */
pointcut createStringBuffer(StringBuffer stringBuffer,

String string): initialization(StringBuffer.new(String)) &&
target(stringBuffer) && args(string) && !within(aoid.aspects.*);

after(StringBuffer stringBuffer, String string):

createStringBuffer(stringBuffer, string) {

{ ... }

}
/* creating String (copying constructor) */
pointcut createStringCtor(String string, String string):

initialization(String.new(String)) && target(string) && args(string) &&
!within(aoid.aspects.*);

after(String string, String string):

createStringCtor(string, string) {

{ ... }

}
/* creating StringBuffer (copying ctor) - similarly*/
/******* third metadata management component: Metadata

Policy Enforcement *******/

/******* Output Vectors -- writing *******/
pointcut servletGetPrintWriter( ): call (PrintWriter

ServletResponse.getWriter( ));

void around( ): servletGetPrintWriter( ) {

PrintWriter pw = proceed( ); /* keeping track of

servlet PrintWriters */

servletPrintWriters.put(pw, new Object( ));

}
pointcut servletRequestWriting(PrintWriter pw, String

string): call (void java.io.PrintWriter.print*(String)) && args(string)
&& target(pw);

void around(PrintWriter pw, String string):

| | |
|---|---|
| servletRequestWriting(pw, string){ | if (servletPrintWriters.get(pw) |
| == NULL) | |

| | |
|---|---|
| proceed( ); | //not a servlet printWriter (e.g., |

PrintWriter associated with a file)

else {

{ ... }

}

}
/******* Output Vectors -- SQL Statement execute *******/
pointcut sqlExec(Statement t, String sql): call

(ResultSet Statement.execute*(*)) && args(sql) && target(t);

around(Statement t, String sql): sqlExec(t, sql) {

{ ... }

}

Any disclosed embodiment may be combined with one or several of the other embodiments shown and/or described. This is also possible for one or more features of the embodiments.

The present invention can be realized in hardware, software, or a combination of hardware and software. Any kind of computer system—or other apparatus adapted for carrying out the method described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

That which is claimed is:

1. A computer program with metadata management function embodied in computer readable medium, the computer program comprising:
a basic program module; and
a metadata management module with intercept definition elements which define intercept points in the basic program module and with intercept instructions which define metadata operations to be performed when an intercept point occurs in the basic program module.

2. The computer program according to claim 1, wherein the metadata management module further comprises a first, a second and a third metadata management component, the first metadata management component being provided for assigning metadata to data elements of the basic program module, the second metadata management component being provided for updating the metadata of the data elements and the third metadata management component being provided for enforcing a metadata policy.

3. The computer program according to claim 2, wherein the first metadata management component comprises intercept definition elements which define as intercept points a set of points in the basic program module where data is entered into the computer program.

4. The computer program according to claim 2, wherein the first metadata management component assigns metadata only to a limited number of data types.

5. The computer program according to claim 2, wherein the second metadata management component comprises intercept definition elements which define as intercept points a set of functions that are operable on data elements of the basic program module.

6. The computer program according to claim 2, wherein the third metadata management component comprises intercept definition elements which define as intercept points a set of actions performed on data elements of the basic program module.

7. The computer program according to claim 1, wherein the computer program is adapted to store the metadata as part of a data element.

8. The computer program according to claim 1, wherein the computer program is adapted to store the metadata in a central repository.

9. The computer program according to claim 1, wherein the metadata management function is implemented by means of Aspect Oriented Software Development.

10. The computer program a according to claim 1, wherein the metadata management module is provided for enforcing data protection.

11. The computer program according to claim 1, wherein the metadata management module is provided for enforcing security.

12. A method for providing a metadata management function to a basic program module of a computer program, the method comprising:
programming a metadata management module with intercept definition elements that define intercept points in the basic program module and that intercept instructions which define metadata operations to be performed when an intercept point occurs in the basic program module; and
linking the metadata management module to the basic program module.

13. A method for running a computer program with metadata management function, the method comprising:
starting a basic program module and a metadata management module of the computer program, wherein the metadata management module comprises intercept definition elements that define intercept points in the basic program module and intercept instructions which define metadata operations to be performed when an intercept point occurs in the basic program module;
observing the basic program module for the occurrence of intercept points by means of the metadata management module; and
performing intercept instructions when an intercept point occurs in the basic program module.

14. A method for providing a metadata management function to a basic program module of a computer program, the method comprising:
analyzing the basic program module;
creating intercept definition elements that define intercept points in the basic program module;
creating intercept instructions which define metadata operations to be performed when an intercept point occurs in the basic program module;
creating a metadata management module by means of the intercept definition elements and the intercept instructions;
linking the metadata management module to the basic program module.
